(19) United States
(12) Patent Application Publication
(10) Pub. No.: US 2024/0232641 A1
(43) Pub. Date: Jul. 11, 2024

(54) METHOD OF GENERATING ENERGY STORAGE SYSTEM CONTROL INFORMATION USING REINFORCEMENT TRAINING RESULT AND COMPUTING DEVICE FOR PERFORMING THE SAME

(71) Applicant: ELECTRONICS AND TELECOMMUNICATIONS RESEARCH INSTITUTE, Daejeon (KR)

(72) Inventor: Cheol-ho SHIN, Sejong-si (KR)

(21) Appl. No.: 18/396,985

(22) Filed: Dec. 27, 2023

(30) Foreign Application Priority Data
Jan. 11, 2023 (KR) 10-2023-0004278

(51) Int. Cl. G06N 3/092

(52) U.S. Cl. CPC G06N 3/092

(57) ABSTRACT

A method of generating energy storage system (ESS) control information using reinforcement training results and a computing device for performing the method are provided. The method includes training a reinforcement training model for reducing peak load of an ESS using power consumption data corresponding to a first period in the past for a building to which the ESS is applied, generating ESS control information corresponding to the first period in the past by applying, to the trained reinforcement training model, the power consumption data corresponding to the first period in the past for the building, and converting the generated ESS control information corresponding to the first period in the past into ESS control information on a daily basis divided into weekdays and holidays and applying the ESS control information on a daily basis divided into weekdays and holidays as ESS control information corresponding to a second period at present.

### CROSS-REFERENCE TO RELATED APPLICATION

This application claims the benefit of Korean Patent Application No. 10-2023-0004278, filed on Jan. 11, 2023, in the Korean Intellectual Property Office, the entire disclosure of which is incorporated herein by reference for all purposes.

### BACKGROUND

### 1. Field of the Invention

One or more embodiments relate to a technique of generating scheduling control information for an energy storage system (ESS), which is one of power demand management methods, using reinforcement training results.

### 2. Description of Related Art

As a conventional power demand management method using an energy storage system (ESS), a scheduling control method is mainly used to charge power energy during light load times and discharge power energy during peak load times, considering preset seasonal load times to reduce peak load.

Recently, accurate power consumption prediction has been performed and by using these prediction results, scheduling of the ESS has been performed so that the amount of power flowing from the system remains constant, or a discharge power schedule of the optimized ESS has been obtained by analyzing a load pattern of a building where power consumption data has been collected. An ESS operation scheduling technique based on long short-term memory (LSTM) has been proposed through error minimization training with the discharge power schedule of the optimized ESS.

Particularly, when a reinforcement training model is applied to generate optimal ESS control information to reduce peak load as a power demand management method, due to the seasonal load characteristics of power, even if two years of power consumption data is monitored, there has been an issue that the amount of data corresponding to the same season and time is very limited.

### SUMMARY

Embodiments provide a method of generating energy storage system (ESS) control information, which is strong to instantaneous changes in power consumption data as the method may be applied on average during similar seasons, since the present disclosure replaces the method of generating ESS control information in real time by receiving environmental information (i.e., a state) at the moment of control as an input to compensate for insufficient training data.

However, technical aspects are not limited to the foregoing aspect, and there may be other technical aspects.

According to an aspect, there is provided a method of generating ESS control information, the method including training a reinforcement training model for reducing peak load of an ESS using power consumption data corresponding to a first period in the past for a building to which the ESS is applied, generating ESS control information corresponding to the first period in the past by applying, to the trained reinforcement training model, the power consumption data corresponding to the first period in the past for the building, and converting the generated ESS control information corresponding to the first period in the past into ESS control information on a daily basis divided into weekdays and holidays and applying the ESS control information on a daily basis divided into weekdays and holidays as ESS control information corresponding to a second period at present.

A date included in the first period in the past may include the same date included in the second period at present.

The applying of the ESS control information on a daily basis divided into weekdays and holidays as ESS control information corresponding to a second period at present may include dividing the generated ESS control information corresponding to the first period in the past into weekday data and holiday data, determining the ESS control information on a daily basis divided into weekdays and holidays by classifying the divided weekday data and the divided holiday data on a daily basis and by deriving an average of the weekday data and the holiday data classified on a daily basis, and using the ESS control information on a daily basis divided into weekdays and holidays as the ESS control information corresponding to the second period at present.

The method may further include repeating, at each update cycle, a process of determining ESS control information on a daily basis corresponding to a fourth period at present using power consumption data corresponding to a third period in the past immediately after the first period in the past.

A date included in the third period in the past may include the same date included in the fourth period at present.

According to another aspect, there is provided a computing device including at least one processor and a memory configured to load or store a program executed by the at least one processor, wherein the program may include training a reinforcement training model for reducing peak load of an energy storage system (ESS) using power consumption data corresponding to a first period in the past for a building to which the ESS is applied, generating ESS control information corresponding to the first period in the past by applying, to the trained reinforcement training model, the power consumption data corresponding to the first period in the past for the building, and converting the generated ESS control information corresponding to the first period in the past into ESS control information on a daily basis divided into weekdays and holidays and applying the ESS control information on a daily basis divided into weekdays and holidays as ESS control information corresponding to a second period at present.

A date included in the first period in the past may include the same date included in the second period at present.

The at least one processor may be configured to divide the generated ESS control information corresponding to the first period in the past into weekday data and holiday data, determine the ESS control information on a daily basis divided into weekdays and holidays by classifying the divided weekday data and the divided holiday data on a daily basis and by deriving an average of the weekday data and the holiday data classified on a daily basis, and use the ESS control information on a daily basis divided into weekdays and holidays as the ESS control information corresponding to the second period at present.

The at least one processor may be configured to repeat, at each update cycle, a process of determining ESS control information on a daily basis corresponding to a fourth period at present using power consumption data corresponding to a third period in the past immediately after the first period in the past.

A date included in the third period in the past may include the same date included in the fourth period at present.

Additional aspects of embodiments will be set forth in part in the description which follows and, in part, will be apparent from the description, or may be trained by practice of the disclosure.

According to an embodiment, time restriction required for artificial intelligence (AI) training may be removed, since approximately one year of preparation time may be secured to generate ESS control information to be used in the same period of the current year by using power consumption data for the same period in the past.

In addition, according to an embodiment, control time delays may be reduced through scheduling control using power consumption data for the same period in the past, rather than real-time control.

Furthermore, according to an embodiment, a strong AI model that may guarantee ESS control performance above a certain level may be provided, since average ESS control information during similar seasons is provided.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of a computing device according to an embodiment;

FIG. 2 is a diagram illustrating a structure of a reinforcement training technique applied to a training model according to an embodiment;

FIG. 3 is a diagram illustrating a process of generating energy storage system (ESS) control information, according to an embodiment;

FIGS. 4A and 4B illustrate examples of generating ESS control information for one month using a trained reinforcement training model according to an embodiment;

FIGS. 5A and 5B illustrate examples of dividing ESS control information on a monthly basis into weekday data and holiday data on a daily basis, according to an embodiment;

FIGS. 6A and 6B are diagrams illustrating ESS control information to be used to control power consumption data for the same month of the current year, according to an embodiment;

FIG. 7 is a diagram illustrating a result of performing ESS control by applying ESS control information generated by a reinforcement training model to power consumption data for the same month of the current year, according to an embodiment;

FIG. 8 is a diagram illustrating an ESS control result on Jan. 11, 2023 (weekday) when peak load occurred, according to an embodiment; and

FIG. 9 is a diagram illustrating functions of generating ESS control information using reinforcement training according to an embodiment.

### DETAILED DESCRIPTION

The following detailed structural or functional description is provided as an example only and various alterations and modifications may be made to the embodiments. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

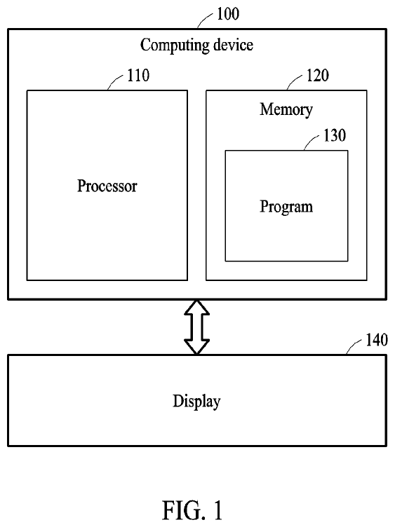

FIG. 1 is a diagram illustrating a configuration of a computing device according to an embodiment.

Referring to FIG. 1, a computing device 100 may include at least one processor 110 and a memory 120 for loading or storing a program 130 performed by the at least one processor 110. The components included in the computing device 100 of FIG. 1 are just an example, and one of ordinary skill in the art may understand that other generally used components may be further included, besides the components illustrated in FIG. 1.

The processor 110 may control the overall operation of each component of the computing device 100. The processor 110 may include at least one of a central processing unit (CPU), a microprocessor unit (MPU), a microcontroller unit (MCU), a graphics processing unit (GPU), a neural processing unit (NPU), a digital signal processor (DSP), or other well-known types of processors in a relevant field of technology. In addition, the processor 110 may perform an operation of at least one application or program to perform the methods/operations described herein according to various embodiments. The computing device 100 may include one or more processors.

The memory 120 may store one of or two or more combinations of various pieces of data, commands, and pieces of information that are used by the components (e.g., the processor 110) included in the computing device 100. The memory 120 may include a volatile memory or a non-volatile memory.

The program 130 may include one or more actions through which the methods/operations described herein according to various embodiments are implemented and may be stored in the memory 120 as software. Here, an operation may correspond to a command that is implemented in the program 130. For example, the program 130 may include instructions configured to perform training a reinforcement training model for reducing peak load of an energy storage system (ESS) using power consumption data corresponding to a first period in the past for a building to which the ESS is applied, generating ESS control information corresponding to the first period in the past by applying, to the trained reinforcement training model, the power consumption data corresponding to the first period in the past for the building, and converting the generated ESS control information corresponding to the first period in the past into ESS control information on a daily basis divided into weekdays and holidays and applying the ESS control information on a daily basis divided into weekdays and holidays as ESS control information corresponding to a second period at present.

When the program 130 is loaded in the memory 120, the processor 110 may execute a plurality of operations to implement the program 130 and may perform the methods/operations described herein according to various embodiments.

An execution screen of the program 130 may be displayed on a display 140. Although the display 140 is illustrated as a separate device connected to the computing device 100 in FIG. 1, the display 140 may be included in the components of the computing device 100 when the computing device 100 is a smartphone, a tablet, or other terminals that are portable by a user. The screen displayed on the display 140 may be a state before information is input to the program 130 or may be an execution result of the program 130.

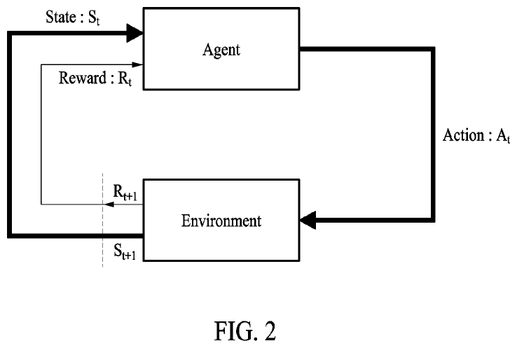

FIG. 2 is a diagram illustrating a structure of a reinforcement training technique applied to a training model according to an embodiment.

The reinforcement training technique may generate, by an agent, an operation (e.g., an action A) according to a purpose of reinforcement training using information collected from an environment and may generate a reward (e.g., a reward R) and new environment information (e.g., a state S) by reflecting changes in the environment according to the operation. The reinforcement training technique is a training method in which such series of processes may be repeatedly trained afterwards, so that a reward value may be maximized when an optimal training result ultimately satisfies the purpose of reinforcement training as much as possible.

In a reinforcement training structure, the environment may represent a control operation environment of an ESS, the environment information (i.e., a state) may represent a date, data for power consumption of a building, ESS remaining quantity, temperature, etc., the operation (i.e., an action) may represent a charging/discharging operation of the ESS, and the reward may represent a compensation value according to the charging/discharging operation of the ESS.

In the present disclosure, a method of generating ESS control information may be provided, which may strongly respond to instantaneous changes in energy consumption patterns using a reinforcement training model after training for ESS control purpose is performed, and therefore, an issue of insufficient training data for the same situation due to the characteristics of power energy monitoring may be alleviated.

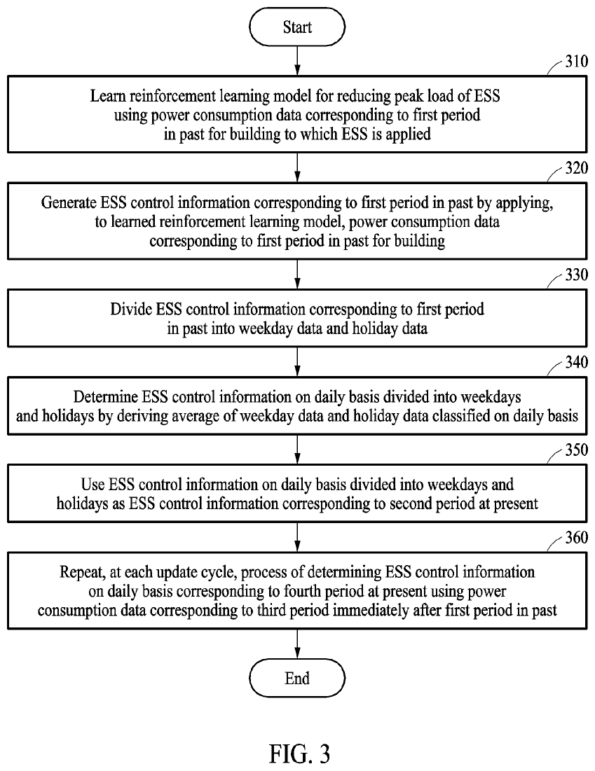

A process of generating ESS control information that may be applied equally on a daily basis for a certain period of time (e.g., one month) in the future using the reinforcement training model trained for the ESS control purpose, such as peak load reduction, is described in detail with reference to FIG. 3 below.

FIG. 3 is a diagram illustrating a process of generating ESS control information, according to an embodiment.

The process of generating ESS control information shown in FIG. 3 may be performed by the processor 110 of the computing device 100. The processor 110 may train a reinforcement training model using power consumption data monitored in the past and may generate the ESS control information to be applied for a certain period of time (e.g., one month) in the future using the trained reinforcement training model. For better understanding, the data used to train the reinforcement training model and generate the ESS control information using the trained reinforcement training model is set to power consumption data monitored in January 2022, and future power consumption data to which ESS control information on a daily basis generated using the power consumption data monitored in January 2022 will be applied is set to data in January 2023.

In operation 310, the processor 110 may train the reinforcement training model for reducing peak load of an ESS using power consumption data corresponding to a first period in the past for a building to which the ESS is applied. For example, in the reinforcement training structure shown in FIG. 2, the processor 110 may input the power consumption data monitored in January 2022 as environment information (e.g., the state S) into an artificial intelligence (AI) model or deep learning model within an agent.

Here, the AI model or deep learning model within the agent may be trained to output an operation (e.g., the action A), which is ESS control information that may optimize a charging/discharging width (e.g., a C-rate) and application point in time to reduce peak load considering the capacity of the ESS using the input power consumption data monitored in January 2022.

In operation 320, the processor 110 may generate ESS control information corresponding to the first period in the past by applying, to the trained reinforcement training model, the power consumption data corresponding to the first period in the past for the building. For example, the processor 110 may generate ESS control information for one month by inputting power consumption data of the same month in the past as the environmental information (e.g., the state S) into the AI model or deep learning model trained using a reinforcement training technique.

Here, the power consumption data of the same month in the past may be the power consumption data monitored in January 2022 and used for the reinforcement training in operation 310. If monitoring data for a longer period of time is used, the processor 110 may additionally use power consumption data monitored in January 2021 or January of the previous year.

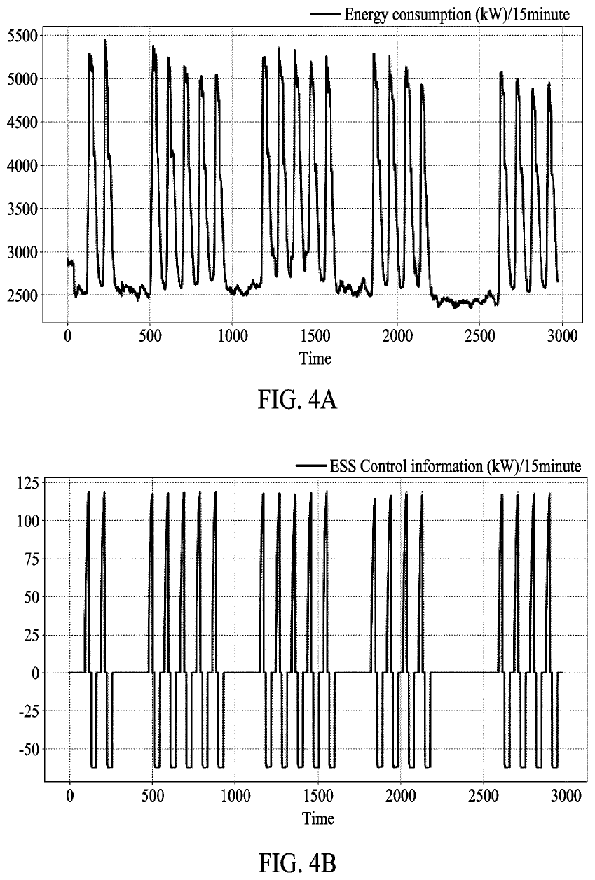

FIGS. 4A and 4B illustrate examples of generating ESS control information for one month using a trained reinforcement training model according to an embodiment. Since monitoring data at 15-minute intervals is used in the present disclosure, as shown in FIG. 4A, the X axis may represent the number of samples of the monitoring data monitored at 15-minute intervals and the Y axis may represent power consumption in 15-minute units (a unit of kilowatt (kW)/15 minutes). Referring to FIG. 4A, the X axis may include 2,976 samples (i.e., 96 samples/1 day*31 days=2,976 samples). However, the monitoring interval of such monitoring data is only an example and is not limited to the above example.

FIG. 4B is a diagram illustrating the ESS control information for one month generated by applying power consumption data for one month (e.g., monitoring data at 15-minute intervals in January 2022) to the trained reinforcement training model.

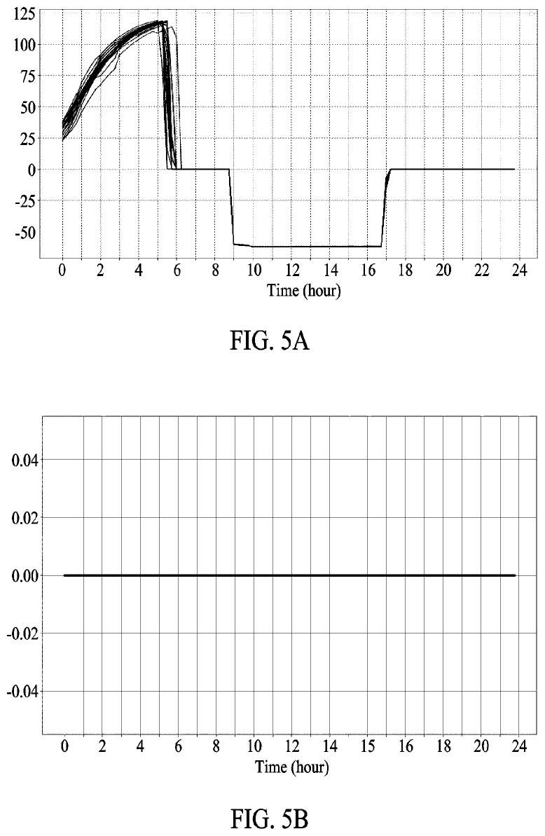

In operation 330, the processor 110 may divide the ESS control information corresponding to the first period in the past into weekday data and holiday data. When the ESS control information for one month generated in operation 320 is divided on a daily basis and classified into weekdays and holidays to be illustrated, the ESS control information may correspond to FIGS. 5A and 5B. In the present disclosure, since the power consumption data monitored in January 2022 is used as an input to generate the ESS control information, the weekday data and the holiday data may be classified into 20 days and 11 days, respectively. For example, FIG. 5A illustrates an example of ESS control information on the weekday data classified on a daily basis and FIG. 5B illustrates an example of ESS control information on the holiday data classified on a daily basis.

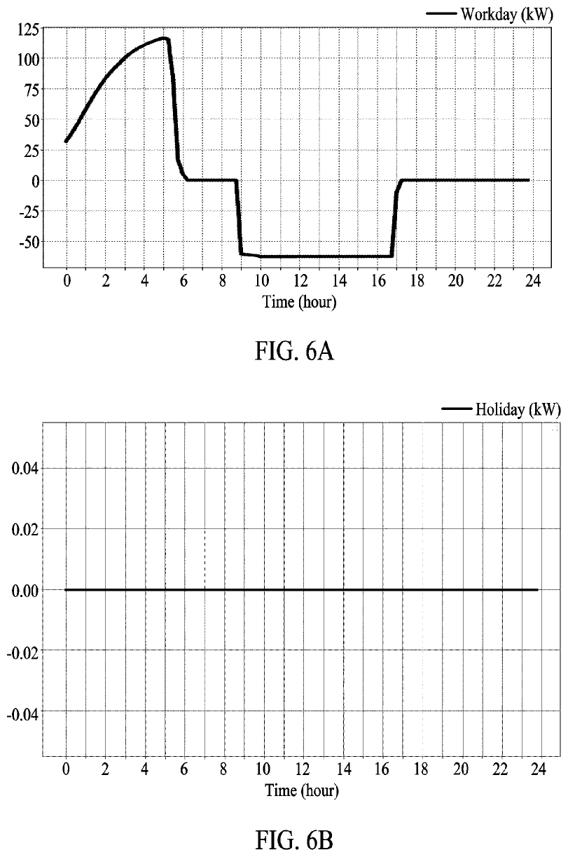

In operation 340, the processor 110 may determine the ESS control information on a daily basis divided into weekdays and holidays by deriving an average of the weekday data and the holiday data classified on a daily basis. For example, the processor 110 may calculate an average of ESS control information corresponding to the weekday data of 20 days classified on a daily basis, as shown in FIG. 6A, thereby deriving the ESS control information for weekdays on a daily basis. Similarly, the processor 110 may calculate an average of ESS control information corresponding to the holiday data of 11 days classified on a daily basis, as shown in FIG. 6B, thereby deriving the ESS control information for holidays on a daily basis.

In the example of the present disclosure, it may be confirmed that the reinforcement training model has been trained that, in the case of holidays, maintaining the ESS in a standby state rather than performing ESS control is more suitable for the purpose of reducing peak load.

In operation 350, the processor 110 may use the ESS control information on a daily basis divided into weekdays and holidays as the ESS control information corresponding to the second period at present. Here, a date included in the first period in the past may be the same as or similar to a date included in the second period at present.

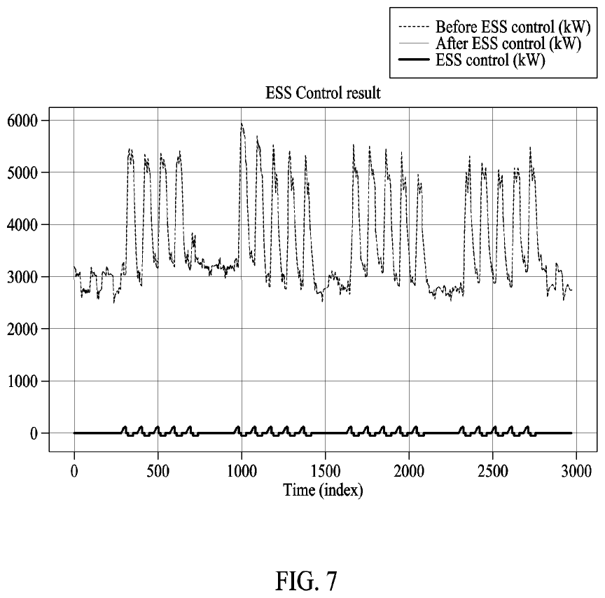

For example, the processor 110 may apply the ESS control information on a daily basis divided into weekdays and holidays, as shown in FIGS. 6A and 6B, to weekdays and holidays of the same month of the current year (e.g., January 2023), respectively, and may obtain ESS control results as shown in FIG. 7.

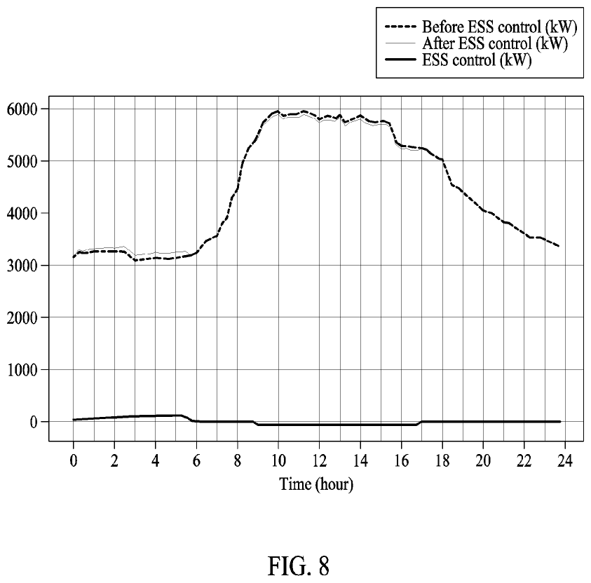

Here, the ESS control information and ESS control effect on Jan. 11, 2023 (i.e., a weekday) when peak load occurred, as shown in FIG. 7, may be illustrated as shown FIG. 8. Referring to FIG. 8, by charging the ESS at the time with light load and discharging the ESS at the time with heavy load, it may be confirmed that the purpose of reinforcement training to reduce peak load is properly achieved by the ESS control information on a daily basis using the reinforcement training proposed in the present disclosure.

Finally, in operation 360, the processor 110 may repeat, at each update cycle, a process of determining ESS control information on a daily basis corresponding to a fourth period at present using power consumption data corresponding to a third period immediately after the first period in the past. Here, a date included in the third period in the past may be the same as or similar to a date included in the fourth period at present.

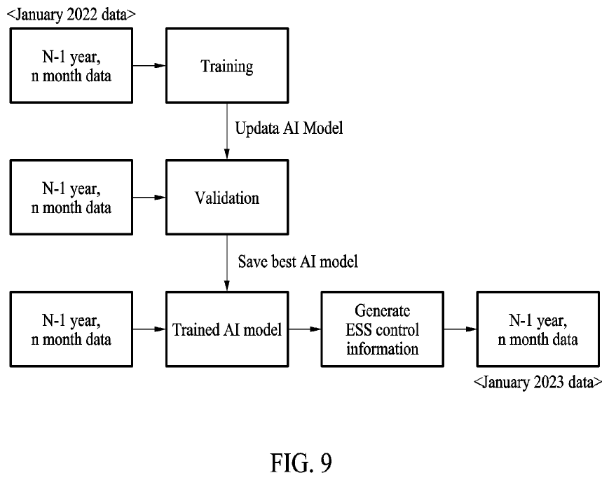

More specifically, the processor 110 may repeat the process from operation 310 to operation 350, as shown in FIG. 9, at each update cycle (one month in the example of the present disclosure) of ESS control information. For example, ESS control information to be applied in January 2023 may be generated using power consumption data monitored in January 2022 and ESS control information to be applied in February 2023 may be generated using power consumption data monitored in February 2022.

The components described in the embodiments may be implemented by hardware components including, for example, at least one DSP, a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using hardware components, software components, or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A method of generating energy storage system (ESS) control information, the method comprising:
training a reinforcement training model for reducing peak load of an ESS using power consumption data corresponding to a first period in the past for a building to which the ESS is applied;
generating ESS control information corresponding to the first period in the past by applying, to the trained reinforcement training model, the power consumption data corresponding to the first period in the past for the building; and
converting the generated ESS control information corresponding to the first period in the past into ESS control information on a daily basis divided into weekdays and holidays and applying the ESS control information on a daily basis divided into weekdays and holidays as ESS control information corresponding to a second period at present.

2. The method of claim 1, wherein
a date included in the first period in the past includes the same date included in the second period at present.

3. The method of claim 1, wherein
the applying of the ESS control information on a daily basis divided into weekdays and holidays as ESS control information corresponding to a second period at present comprises:
dividing the generated ESS control information corresponding to the first period in the past into weekday data and holiday data;
determining the ESS control information on a daily basis divided into weekdays and holidays by classifying the divided weekday data and the divided holiday data on a daily basis and by deriving an average of the weekday data and the holiday data classified on a daily basis; and
using the ESS control information on a daily basis divided into weekdays and holidays as the ESS control information corresponding to the second period at present.

4. The method of claim 1, further comprising:
repeating, at each update cycle, a process of determining ESS control information on a daily basis corresponding to a fourth period at present using power consumption data corresponding to a third period in the past immediately after the first period in the past.

5. The method of claim 4, wherein
a date included in the third period in the past includes the same date included in the fourth period at present.

6. A computing device comprising:
at least one processor; and
a memory configured to load or store a program executed by the at least one processor,
wherein the program comprises:
training a reinforcement training model for reducing peak load of an energy storage system (ESS) using power consumption data corresponding to a first period in the past for a building to which the ESS is applied;
generating ESS control information corresponding to the first period in the past by applying, to the trained reinforcement training model, the power consumption data corresponding to the first period in the past for the building; and
converting the generated ESS control information corresponding to the first period in the past into ESS control information on a daily basis divided into weekdays and holidays and applying the ESS control information on a daily basis divided into weekdays and holidays as ESS control information corresponding to a second period at present.

7. The computing device of claim 6, wherein
a date included in the first period in the past includes the same date included in the second period at present.

8. The computing device of claim 6, wherein
the at least one processor is configured to:
divide the generated ESS control information corresponding to the first period in the past into weekday data and holiday data;
determine the ESS control information on a daily basis divided into weekdays and holidays by classifying the divided weekday data and the divided holiday data on a daily basis and by deriving an average of the weekday data and the holiday data classified on a daily basis; and
use the ESS control information on a daily basis divided into weekdays and holidays as the ESS control information corresponding to the second period at present.

9. The computing device of claim 6, wherein
the at least one processor is configured to repeat, at each update cycle, a process of determining ESS control information on a daily basis corresponding to a fourth period at present using power consumption data corresponding to a third period in the past immediately after the first period in the past.

10. The computing device of claim 9, wherein
a date included in the third period in the past includes the same date included in the fourth period at present.
